(19) United States
(12) Patent Application Publication
(10) Pub. No.: US 2014/0108164 A1
(43) Pub. Date: Apr. 17, 2014

(54) DIALOG BOX MANAGEMENT SYSTEM, USER TERMINAL, DIALOG BOX EXPOSURE METHOD AND METHOD FOR CONFIGURING DIALOG BOX EXPOSURE USING THE SAME

(71) Applicant: MOCOPLEX, INC., Seoul (KR)

(72) Inventor: Na-Ra PARK, Seoul (KR)

(73) Assignee: MOCOPLEX, INC., Seoul (KR)

(21) Appl. No.: 13/716,112

(22) Filed: Dec. 15, 2012

(30) Foreign Application Priority Data
Oct. 17, 2012 (KR) 10-2012-0115646

(51) Int. Cl. G06Q 30/02

(52) U.S. Cl. CPC G06Q 30/0277
USPC 705/14.73

(57) ABSTRACT

A dialog box management system, a user system, a dialog box exposure method and a method for configuring dialog box exposure using the same are provided. The dialog box management system includes a communication unit which receives one or more information among application information, mobile web information, and dialog box management information from a registrant terminal registering applications or mobile webs, transmits a dialog box control program to the registrant terminal, and transmits dialog box management information for each application or dialog box management information for each mobile web to a user terminal executing applications or accessing mobile webs; an information management unit which registers and manages the dialog box management information for application or the dialog box management information for each mobile web; and a unit for managing a dialog box control program which manages the dialog box control program.

### BACKGROUND

1. Field

The present invention relates to a dialog box management system, a user system, a dialog box exposure method and a method for configuring dialog box exposure using the same, especially wherein the dialog box management system controls dialog box exposure, based on dialog box management information for configuring exposure conditions as well as the content of the dialog box, without the need to newly develop and distribute applications in order to reflect a new dialog box logic, and thus, information may be effectively delivered to users, and developers may more conveniently develop applications.

2. Description of the Related Art

As technologies in relation to smart phones or smart pads advance, various kinds of applications and mobile webs are developed. Application or mobile web developers/operators expose a dialog box through applications or mobile webs in order to deliver particular information to users of the applications or mobile webs. According to a conventional method for developing applications or mobile web, a developer implements a logic in relation to dialog box exposure at an expected position in advance, so that the dialog box with preset content may be exposed on applications or mobile webs according to preset conditions. Therefore, when a new exposure condition is required to be inserted or the content of the dialog box is required to be modified, there is a problem in which the application or mobile web developers/operators have to modify or newly develop programs of applications or mobile webs, and then re-distribute them.

Besides, a mobile advertising market in which advertisements are exposed through applications or mobile webs is growing.

Advertisers may register mobile advertisements in a mobile advertising platform, and application developers/operators or mobile web developers/operators may expose the advertisements registered in the mobile advertising platform to their applications or mobile webs.

Accordingly, the advertisers may easily expose advertisements, and the application developers/operators or the mobile web developers/operators may earn mobile advertising revenue.

Generally, a conventional mobile advertising system in which advertisements are exposed through applications or mobile webs has had a type of full-screen advertisement in which the advertisements are displayed on the whole mobile screen. These advertisements highly satisfy advertisers, while causing application users to inconveniently use their applications, so that the application users have dissatisfaction and dislike with the full-screen advertisements.

### SUMMARY

The task of the present invention is to provide a dialog box management system, a user system, a dialog box exposure method and a method for configuring dialog box exposure using the same in which a dialog box management system controls dialog box exposure, based on dialog box management information for configuring exposure conditions as well as the content of the dialog box, without the need to newly develop and distribute applications in order to reflect a new dialog box logic, and thus, information may be effectively delivered to users, and developers may more conveniently develop applications.

A dialog box management system according to one embodiment of the present invention is so configured as to comprise a communication unit which receives one or more information among application information, mobile web information, and dialog box management information from a registrant terminal registering applications or mobile webs, transmits a dialog box control program to the registrant terminal, and transmits dialog box management information for each application or dialog box management information for each mobile web to a user terminal executing applications or accessing mobile webs; an information management unit which registers and manages the dialog box management information for application or the dialog box management information for each mobile web; and a unit for managing a dialog box control program which manages the dialog box control program.

The application information may comprise one or more information among application identification information and information on an Operating System (OS) supporting applications.

The dialog box management information for each application or the dialog box management information for each mobile web may comprise one or more information among dialog box exposure condition information for configuring exposure conditions of a dialog box, dialog box content information for configuring the content of a dialog box, and dialog box control information for controlling a dialog box on applications or mobile webs.

The dialog box management information for each application or the dialog box management information for each mobile web may further comprise advertisement management information for controlling advertisement exposure.

The advertisement management information may respond to the dialog box content information. The communication unit may receive user terminal usage information and advertisement usage information from the user terminal. Here, the dialog box management system may further comprise a statistics management unit which extracts statistical data on user terminals from the user terminal usage information, or extracts statistical data on advertisements from the advertisement usage information.

The statistical data on user terminals may comprise statistical data in relation to applications installed in the user terminal, or statistical data in relation to mobile webs that the user terminal accesses.

A user terminal executing applications or accessing mobile webs according to one embodiment of the present invention is so configured as to comprise an execution unit which executes applications or mobile webs to which a dialog box control program distributed from a dialog box management system is applied; a transmitting and receiving unit which receives dialog box management information for each application or dialog box management information for each mobile web from the dialog box management system; and an exposure control unit which controls dialog box exposure, based on the dialog box management information for each application or the dialog box management information for each mobile web.

The dialog box management information for each application or the dialog box management information for each mobile web may comprise one or more information among dialog box exposure condition information for configuring exposure conditions of a dialog box, dialog box content information for configuring the content of a dialog box, and dialog box control information for controlling a dialog box on applications or mobile webs.

The dialog box management information for each application or the dialog box management information for each mobile web may further comprise advertisement management information for controlling advertisement exposure.

The advertisement management information may respond to the dialog box content information.

The user terminal may further comprise an advertising system interface unit which receives one or more mobile advertisements from one or more advertising systems, based on the dialog box management information for each application or the dialog box management information for each mobile. The user terminal may further comprise a usage information collection unit which collects one or more information among user terminal usage information for each user terminal, advertisement usage information for each application, and advertisement usage information for each mobile web. Here, the transmitting and receiving unit may transmit one or more information among the user terminal information for each user terminal, the advertisement usage information for each application, and the advertisement usage information for each mobile web to the dialog box management system.

A dialog box exposure method of a user terminal according to one embodiment of the present invention is so configured as to comprise executing applications or mobile webs to which a dialog box control program distributed from a dialog box management system is applied, receiving dialog box management information for each application or dialog box management information for each mobile web from the dialog box management system, and controlling exposure of a dialog box based on the dialog box management information for each application or the dialog box management information for each mobile web.

A method for configuring dialog box exposure of a registrant terminal registering applications or mobile webs according to one embodiment of the present invention is so configured as to comprise registering application information or mobile web information in a dialog box management system, registering dialog box management information for each application or dialog box management information for each mobile web in the dialog box management system, receiving a dialog box control program required to expose a dialog box of applications or mobile webs from the dialog box management system according to the dialog box management information for each application or the dialog box management information for each mobile web, and applying the dialog box control program to the applications or the mobile webs.

The method for configuring dialog box exposure may further comprise registering the application information or the mobile web information in one or more advertising systems providing mobile advertisements, receiving a program for advertisement exposure which is required to expose the mobile advertisements from the one or more advertising systems, and applying the program for advertisement exposure to the applications or the mobile webs.

The dialog box management information for each application or the dialog box management information for each mobile web may comprise one or more information among dialog box exposure condition information for configuring exposure conditions of a dialog box, dialog box content information for configuring the content of a dialog box, and dialog box control information for controlling a dialog box on applications or mobile webs.

The dialog box management information for each application or the dialog box management information for each mobile web may further comprise advertisement management information for controlling advertisement exposure.

The advertisement management information may respond to the dialog box content information. The step of registering the dialog box management information may comprise configuring the dialog box management information, simulating exposure of a dialog box according to the configured dialog box management information, and modifying the dialog box management information according to the simulation result.

The step of registering the dialog box management information may comprise configuring the dialog box management information, receiving statistical data according to user terminal usage information or advertisement usage information, and modifying the dialog box management information according to the statistical data.

### BRIEF DESCRIPTION OF THE DRAWINGS

FIG. 1 illustrates an environment to which a dialog box management system is applied according to one embodiment of the present invention.

FIG. 2 illustrates a dialog box management system according to one embodiment of the present invention in a schematic view.

FIG. 3 illustrates a user terminal according to one embodiment of the present invention in a schematic view.

FIG. 4 is a flow chart of a preparation process for dialog box exposure according to one embodiment of the present invention.

FIG. 5 is a flow chart of an execution process for dialog box exposure according to one embodiment of the present invention.

FIG. 6 is a flow chart of a management process for dialog box exposure of a dialog box management system according to one embodiment of the present invention.

FIG. 7 illustrates an example in which a registrant terminal registers dialog box management information in a dialog box management system according to one embodiment of the present invention.

### DETAILED DESCRIPTION

Hereinafter, the present invention will be described in detail with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Throughout the description and claims of this specification, the word “comprise” and variations thereof, such as “comprising” and “comprises” means “including but not limited to”, and is not intended to exclude other components.

In addition, the term “unit” described in this specification means one unit processing one or more functions or operations, and may be implemented by hardware or software, and a combination thereof.

In this specification, a terminal may be referred to as a mobile station (MS), a mobile terminal (MT), a subscriber station (SS), a portable subscriber station (PSS), a user equipment (UE), an access terminal (AT), etc. In this specification, the terminal may include entire or partial functions of the terminal, the mobile terminal, the mobile station, the subscriber station, the portable subscriber station, the user equipment, the access terminal, etc. The terminal may be a personal computer (PC), a notebook, a smart phone, a smart pad, etc.

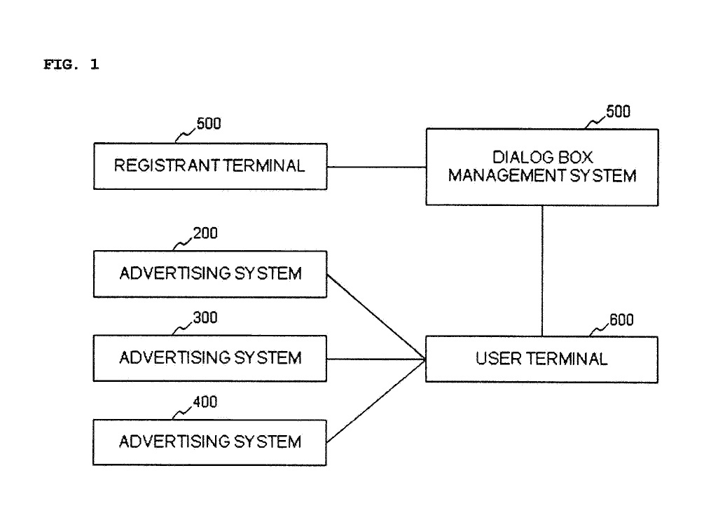

FIG. 1 illustrates an environment to which a dialog box management system is applied according to one embodiment of the present invention. Referring to FIG. 1, the dialog box management system 100 communicates with a registrant terminal 500 and a user terminal 600. The dialog box management system 100 manages scheduling information of a dialog box (e.g., the content and exposure conditions of the dialog box) exposed through the user terminal 600.

The dialog box management system 100 receives dialog box management information on applications and mobile webs from the registrant terminal 500, and transmits the dialog box management information to the user terminal 600. The dialog box management information may comprise one or more information among dialog box exposure condition information for configuring exposure conditions of a dialog box, dialog box content information for configuring the content of a dialog box, and dialog box control information for controlling a dialog box.

The dialog box exposure condition information relates to conditions for exposing a dialog box, and may comprise exposure conditions which enable a dialog box to be exposed, for example, when an application begins, when page A is opened, when page B is opened, or when an application is exited. In addition, according to one embodiment, the dialog box exposure condition information may comprise detailed dialog box exposure conditions which enable a dialog box to be exposed, for example, after an application begins more than certain times, at all times after an application begins, or with a certain probability when an applications begins.

The dialog box content information relates to the content which is included in a dialog box, and may comprise a title as well as the content of a dialog box including images, texts, etc. According to one embodiment, the content of a dialog box may comprise notices, help, messages with specific objects, events, own publicity, etc. For example, the dialog box may have the content such as “Use such and such a function in this way.” in case of the help, “Leave your reviews” in case of the messages with specific objects, “Join such and such an event” in case of the events, and “such and such an application is newly released” in case of the own publicity.

The dialog box control information relates to the control of a dialog box, and may comprise information on, for example, what buttons or links are displayed on a dialog box, what the number of buttons is, what operations are performed when a certain button displayed on a dialog box is clicked (e.g., close a dialog box, open a browser, dial, call an internal function, etc.), what a page is moved to or what a mobile web is accessed when a certain link in a dialog box is clicked, whether to receive an input from a user using a certain input form, etc.

The dialog box management information may further comprise advertisement management information for controlling advertisement exposure in addition to the dialog box exposure condition information, the dialog box content information, and the dialog box control information. In the dialog box management system according to one embodiment of the present invention, a dialog box may comprise its own content as well as advertisements. The advertisements included in the dialog box are displayed not on the whole mobile screen, but in a part of the dialog box, so that application users have less dislike and the dialog box is displayed as a type of pop-up window. Therefore, the advertisements can attract users' attention, and thus, there is an advantage that has excellent advertising effects.

Accordingly, when advertisements are included in a dialog box, the dialog box management information may further comprise the advertisement management information. Here, the advertisement management information may respond to the dialog box content information. Therefore, a dialog box is exposed after including advertisements in relation to the content of the dialog box, so that advertisers may effectively play advertisements and users may obtain useful business information.

The advertisement management information may comprise information on an advertising space in a dialog box. The information on an advertising space in a dialog box relates to the size and shape of a space on which advertisements are displayed in a dialog box.

The registrant terminal 500 represents a terminal of applications or mobile webs developers/operators. The user terminal 600 represents a terminal of a user who downloads and executes an application, or accesses a mobile web. The user terminal 600 receives the dialog box management information registered by the registrant terminal 500 from the dialog box management system 100, and then exposes a dialog box according to the dialog box management information when executing an application developed/operated by the registrant terminal 500 or when accessing a mobile web.

In case that the dialog box management information is advertisement management information, the user terminal 600 may receive mobile advertisements from advertising systems 200, 300, and 400 according to the received advertisement management information.

The advertising systems 200, 300, and 400 may be used mixed with a mobile advertising platform. The advertising systems 200, 300, and 400 receive mobile advertisements registered by advertisers, and then provide the received mobile advertisements to applications or mobile webs of the user terminal 600.

According to one embodiment, the registrant terminal 500 configures scheduling information on dialog box exposure, the dialog box management system 100 transmits the scheduling information to the user terminal 600, and the user terminal 600 exposes a dialog box based on the scheduling information.

Hereinafter, a dialog box management system 100, a user terminal 600, and a dialog box exposure method as well as a method for configuring dialog box exposure of a registrant terminal 500 using the same are described in detail. For convenience of description, a case in which a user terminal exposes a dialog box including a mobile advertisement is exemplarily described. However, embodiments of the present invention are not limited thereto, and may being similarly applied to exposure of a dialog box which does not include an advertisement.

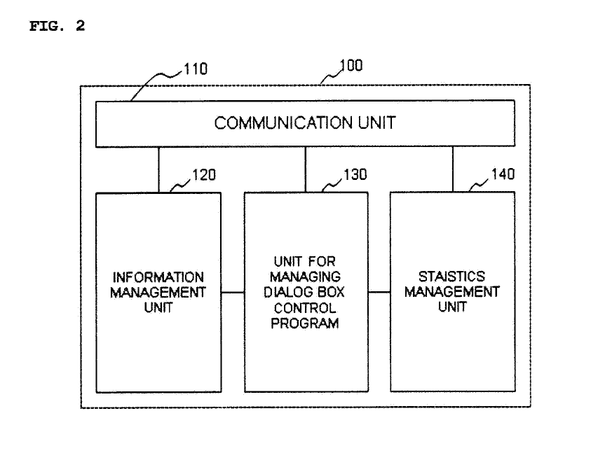

FIG. 2 illustrates a dialog box management system according to one embodiment of the present invention in a schematic view. Referring to FIG. 2, the dialog box management system 100 according to one embodiment of the present invention may be so configured as to comprise a communication unit 110, an information management unit 120, a unit for managing a dialog box control program 130, and a statistics management unit 140. Although the dialog box management system 100 shown in FIG. 2 is provided according to one embodiment, components of the dialog box management system are not limited to the embodiment shown in FIG. 2, and a part of the components may be added, modified, or deleted as necessary.

The communication unit 110 receives one or more information among application information, mobile web information, and dialog box management information from the registrant terminal 500 registering applications or mobile webs. The communication unit 110 transmits a dialog box control program to the registrant terminal 500. The communication unit 110 transmits dialog box management information for each application or dialog box management information for each mobile web to the user terminal 600 executing applications or accessing mobile webs. Also, the communication unit 110 may receive user terminal usage information or advertisement usage information from the user terminal 600.

The information management unit 120 registers and manages the dialog box management information for each application or the dialog box management information for each mobile web.

The unit for managing a dialog box control program 130 manages a dialog box control program (i.e., Software Development Kit, SDK). The dialog box control program is a module required to expose a dialog box according to the dialog box management information. The dialog box control program may comprise total functions, e.g., management and exposure of a dialog box, exposure of an advertisement included in a dialog box, etc., provided by the dialog box management system 100,

The statistics management unit 140 converts the user terminal usage information or the advertisement usage information received from the user terminal 600 into statistics.

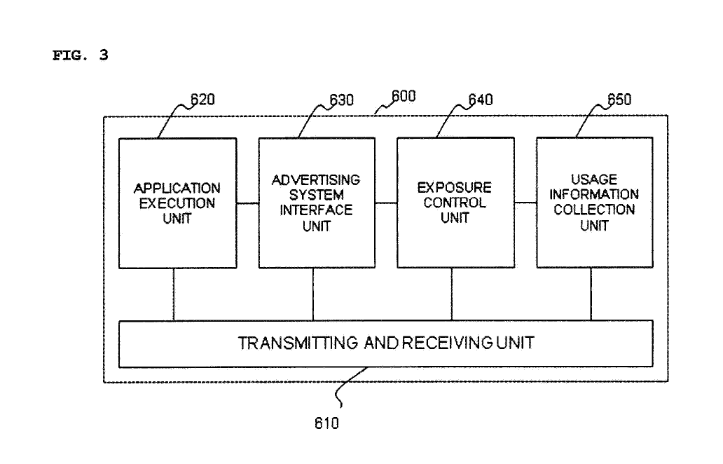

FIG. 3 illustrates a user terminal according to one embodiment of the present invention in a schematic view. Referring to FIG. 3, the user terminal 600 according to one embodiment of the present invention may be so configured as to comprise a transmitting and receiving unit 610, an application execution unit 620, an advertising system interface unit 630, an exposure control unit 640, and a usage information collection unit 650. Although the user terminal 600 shown in FIG. 3 is provided according to one embodiment, components of the user terminal are not limited to the embodiment shown in FIG. 3, and a part of the components may be added, modified, or deleted as necessary.

The transmitting and receiving unit 610 receives dialog box management information for each application or dialog box management information for each mobile web from a dialog box management system 100, or transmits user terminal usage information or advertisement usage information to the dialog box management system 100. The transmitting and receiving unit 610 may also perform general transmitting and receiving functions of the user terminal 600.

The application execution unit 620 executes downloaded applications, or accesses mobile webs. The applications or mobile webs may be those to which a dialog box control program distributed from the dialog box management system 100 is applied.

The advertising system interface unit 630 receives one or more mobile advertisements from one or more advertising systems based on dialog box management information for each application or dialog box management information for each mobile web. The advertising system interface unit 630 may be implemented in each of the advertising systems 200, 300, and 400, and be compatible with the each advertising system. The dialog box control program distributed from the dialog box management system 100 may comprise a virtual advertising system interface unit.

The exposure control unit 640 exposes a dialog box according to dialog box management information for each application or dialog box management information for each mobile web. The exposure control unit 640 may receive mobile advertisements from a plurality of unstandardized advertising systems through the virtual advertising system interface unit, and expose mobile advertisements in an advertising space of a dialog box according to the dialog box management information.

The usage information collection unit 650 collects user terminal usage information or advertisement usage information from users.

A dialog box exposure method and a method for configuring dialog box exposure according to one embodiment of the present invention may be divided into a preparation process, an execution process, and a registration process. Hereinafter, corresponding steps according to the divided processes are described.

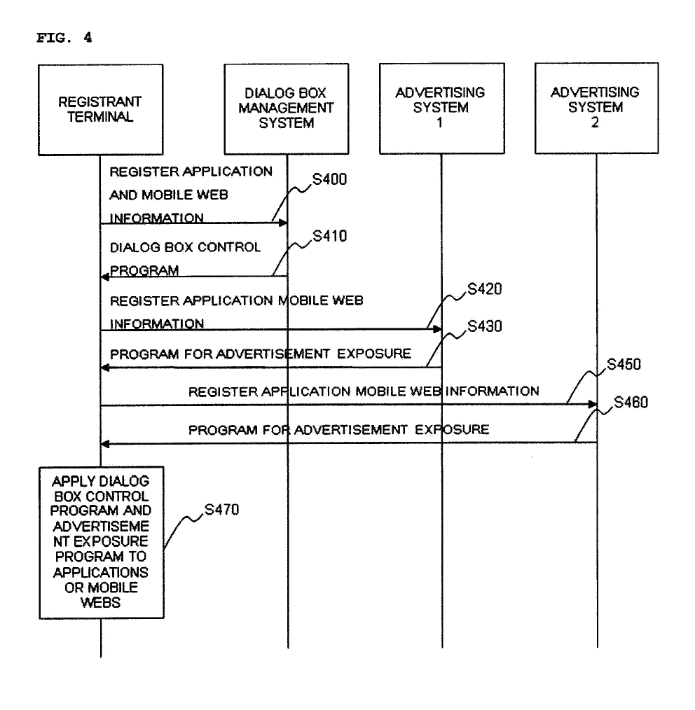

FIG. 4 is a flow chart of a preparation process for dialog box exposure according to one embodiment of the present invention.

Referring to FIG. 4, a registrant terminal 500 registers application information or mobile web information in a dialog box management system 100 (S410), and receives a dialog box control program from the dialog box management system 100 (S420). Here, the dialog box control program provided from the dialog box management system 100 is a module required to expose a dialog box according to dialog box management information for each application or dialog box management information for each mobile web.

The application information may comprise one or more information among application identification information and information on an Operating System (OS) supporting applications. The information on an OS supporting the application may comprise, for example, that on whether the supporting OS is the Android OS or the iPhone OS. In addition, the information on an OS supporting applications may comprise version information of the corresponding OS. The application identification information may be an application title, an application Uniform Resource Locator (URL) address when being registered in an application market, an application Identification (ID), etc.

The mobile web information may comprise a URL address assigned to a mobile web.

The registrant terminal 500 registers the application information or mobile web information in one or more advertising systems (S430 and S450), and receives a program for advertisement exposure from the each advertising system (S440 and S460).

The program for advertisement exposure is a Software Development Kit (SDK) provided to each advertising system. The program for advertisement exposure is a module required to expose a mobile advertisement, which is received from the each advertising system, in a dialog box. The program for advertisement exposure is included in the dialog box control program, thereby controlling advertisements exposed in the dialog box.

The registrant terminal 500 applies the dialog box control program received from the dialog box management system 100 as well as the program for advertisement exposure received from the each advertising system to applications or mobile webs (S460). Accordingly, the applications or mobile webs may receive mobile advertisements from the each advertising system according to dialog box management information registered in the dialog box management system, and then embed the mobile advertisements in a dialog box.

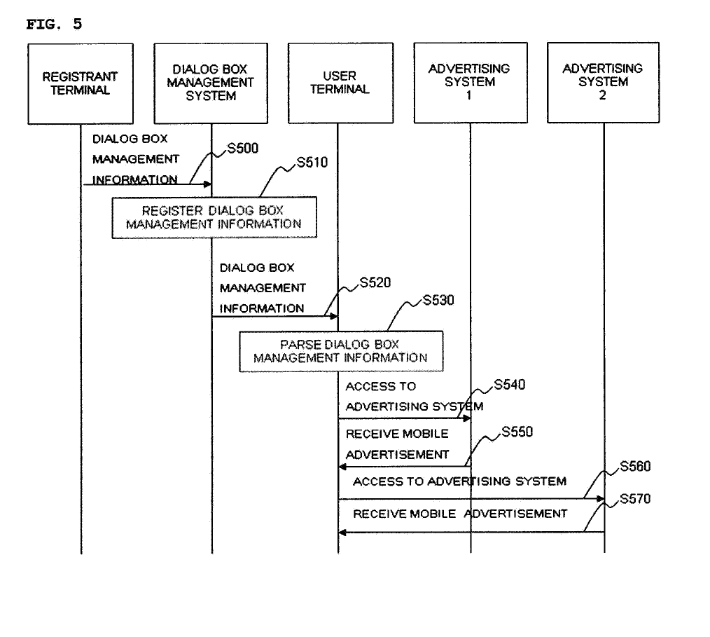

FIG. 5 is a flow chart of an execution process for dialog box exposure according to one embodiment of the present invention.

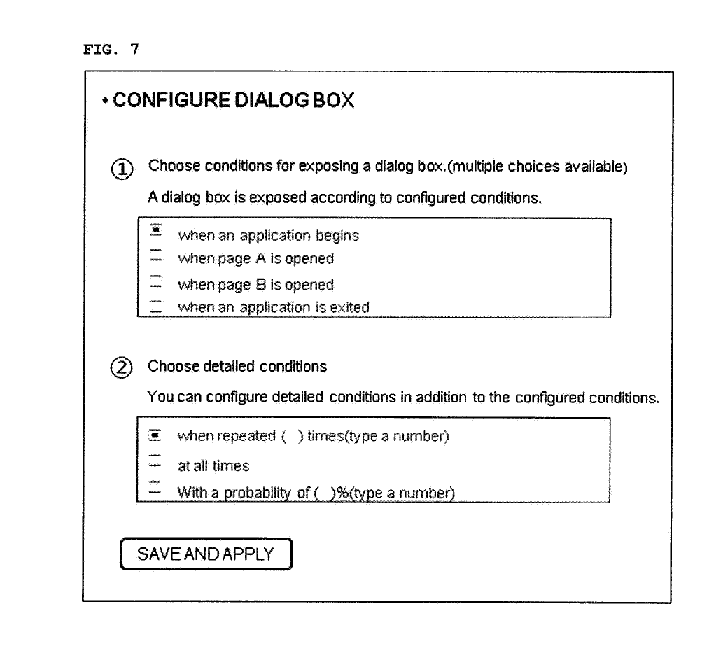

Referring to FIG. 5, a registrant terminal 500 transmits dialog box management information to a dialog box management system 100 (S500), and the dialog box management system 100 registers the dialog box management information (S510). Here, the dialog box management information may comprise one or more information among dialog box exposure condition information for configuring exposure conditions of a dialog box, dialog box content information for configuring the content of a dialog box, and dialog box control information for controlling a dialog box on applications or mobile webs. FIG. 7 illustrates an example in which a registrant terminal registers dialog box management information in a dialog box management system. As shown in FIG. 7, the registrant terminal 500 may configure conditions for exposing a dialog box. In addition, the registrant terminal 500 may additionally configure detailed conditions to the configured conditions. Here, the dialog box management information may be registered in each application or each mobile web.

Although not shown, the dialog box management information may further comprise advertisement management information for controlling advertisement exposure. Here, the advertisement management information may comprise information on an advertising space in a dialog box in order to configure the shape, size, position, etc. of the advertising space in the dialog box. Here, the advertisement management information may be registered in each application or each mobile web.

In addition, although not shown, the registrant terminal 500 may modify the dialog box management information. For example, after the dialog box management information is randomly configured, dialog box exposure may be simulated through the dialog box management system 100. After the simulation result is reflected, the content and exposure conditions of a dialog box, an advertising system providing advertisements, etc. may be controlled.

The dialog box management system 100 transmits the dialog box management information registered by the registrant terminal 500 to a user terminal 600 executing corresponding applications or accessing mobile webs (S520).

The user terminal 600 parses the dialog box management information received from the dialog box management system 100 (S530), accesses a plurality of the adverting systems by means of a schedule which is configured according to the dialog box management information (S540 and S560), and receives mobile advertisements (S550 and S570).

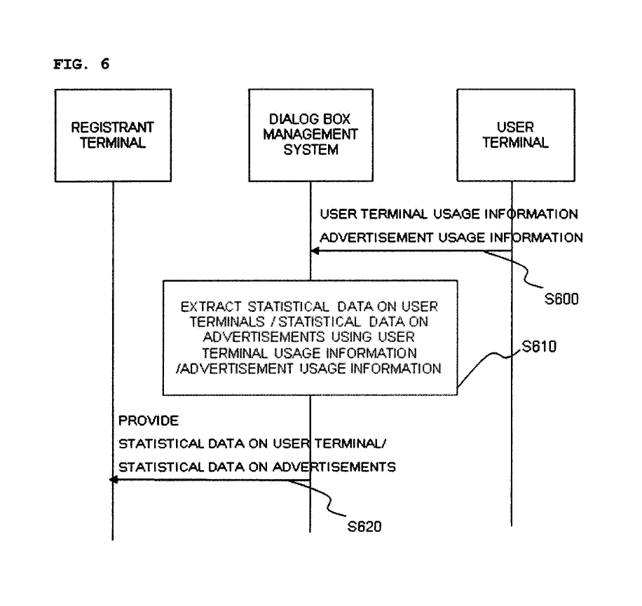

FIG. 6 is a flow chart of a management process for dialog box exposure of a dialog box management system according to one embodiment of the present invention.

Referring to FIG. 6, when a user terminal 600 exposes a dialog box and a mobile advertisement through applications or mobile webs, the dialog box management system 100 receives user terminal usage information and advertisement usage information from the user terminal 600 (S600). The user terminal usage information may be, for example, that in relation to applications installed in the user terminal, that in relation to mobile webs which the user terminal accesses, etc. The advertisement usage information may be, for example, that in relation to which a user of the user terminal 600 touches an advertisement through a user interface. The information in relation to which the user touches the advertisement may represent the number of times or the frequency that the advertisement is touched, dragged, tapped, and scrolled.

The dialog box management system 100 extracts statistical data on user terminals and advertisements using the user terminal usage information and the advertisement usage information received from the user terminal 600 (S610). The statistical data on user terminals may be, for example, that in relation to applications installed in the user terminal 600 or mobile webs which the user terminal 600 accesses. That is, the statistical data on user terminals may comprise information on what fields of applications are of great importance among the installed applications, what kinds of applications are mostly used, what kinds of mobile webs are registered in the bookmark, what kinds of mobile webs are mostly visited, etc. The statistical data on advertisements may be, for example, one or more data among statistical data by advertisement, time, and user. That is, the statistical data on advertisements may comprise information on what kinds of advertisements are popular, when the number of times that the advertisement is touched is high, and what kinds of advertisements users prefer according to gender, age, region, etc.

The dialog box management system 100 provides the extracted statistical data on user terminals and advertisements to a registrant terminal 500 (S620).

The registrant terminal 500 may modify dialog box management information, based on the statistical data on user terminals and advertisements. For example, the registrant terminal 500 may receive statistical data on advertisement according to preset advertisement management information, and modify the advertisement management information so that an exposure rate of advertisements becomes high. In addition, for example, when a number of applications in relation to games are installed in the user terminal, the registrant terminal 500 may modify the advertisement management information so that an exposure rate of advertisements in relation to the games becomes high.

As such, application developers/operators or mobile web developers/operators may control the content, exposure conditions, etc. of a dialog box on applications or mobile webs on-line. Therefore, whenever the content, exposure conditions, etc. of the dialog box is desired to be modified, there is no need to modify or newly develop, and then re-distribute programs of applications or mobile webs.

In addition, the application developers/operators or the mobile web developers/operators can easily obtain an additional space for playing mobile advertisements using a dialog box, which is exposed as described above, outputted from a plurality of mobile advertising platforms, thereby effectively exposing advertisements to their applications or mobile webs. Accordingly, advertising revenue may be maximized. Also, advertisements are included in a part of a dialog box displayed as a type of pop-up window, instead of being exposed as a type of full-screen advertisement in which advertisements are displayed on the whole mobile screen, thereby enabling application users to use applications without inconvenience, and thus, dislike of the application users can not be caused and advertising can be effectively played.

The above-mentioned embodiments of the present invention may be implemented not merely by a device and a method, but also by a program performing functions which correspond to a configuration of the embodiments of the present invention, or a recording medium in which the program is recorded.

Although the specific embodiments of the present invention have been illustrated and described herein, the technical ideas of the present invention are not limited to the accompanying drawings and the foregoing description. In addition, it is appreciated by those skilled in the art that various modifications may be made without departing from the ideas of the present invention, and these modifications are within the claims of the present invention, without departing from the spirit of the present invention.

1. A dialog box management system comprising:
a communication unit which receives one or more information among application information, mobile web information, and dialog box management information from a registrant terminal registering applications or mobile webs, transmits a dialog box control program to the registrant terminal, and transmits dialog box management information for each application or dialog box management information for each mobile web to a user terminal executing applications or accessing mobile webs;
an information management unit which registers and manages the dialog box management information for application or the dialog box management information for each mobile web; and
a unit for managing a dialog box control program which manages the dialog box control program.

2. The dialog box management system according to claim 1, wherein the application information comprises one or more information among application identification information and information on an Operating System (OS) supporting applications.

3. The dialog box management system according to claim 1, wherein the dialog box management information for application or the dialog box management information for each mobile web comprises one or more information among dialog box exposure condition information for configuring exposure conditions of a dialog box, dialog box content information for configuring the content of a dialog box, and dialog box control information for controlling a dialog box on applications or mobile webs.

4. The dialog box management system according to claim 3, wherein the dialog box management information for application or the dialog box management information for each mobile web further comprises advertisement management information for controlling advertisement exposure.

5. The dialog box management system according to claim 4, wherein the advertisement management information responds to the dialog box content information.

6. The dialog box management system according to claim 4, wherein the communication unit receives user terminal usage information or advertisement usage information from the user terminal, and the dialog box management system further comprises a statistics management unit extracting statistical data on user terminals from the user terminal usage information or extracting statistical data on advertisements from the advertisement usage information.

7. The dialog box management system according to claim 6, wherein the statistical data on user terminals comprises statistical data in relation to applications installed in the user terminal, or statistical data in relation to mobile webs which the user terminal accesses.

8. A dialog box management system which provides a dialog box control module required to expose a dialog box to a registrant terminal according to dialog box management information for each application or dialog box management information for each mobile web, and provides a dialog box exposure means to a user terminal,
wherein the dialog box exposure means provided to the user terminal comprises:
a transmitting and receiving module which receives dialog box management information for each application or dialog box management information for each mobile web from the dialog box management system, and transmits user terminal usage information;
an interface module which receives content from at least one outside content providing system, based on the dialog box management information for each application or the dialog box management information for each mobile web received from the dialog box management system;
an exposure control module which exposes a dialog box according to the dialog box management information for each application or the dialog box management information for each mobile web; and
a usage information collection module which collects the user terminal usage information to be transmitted from the transmitting and receiving module to the dialog box management system.

9. The dialog box management system according to claim 8, wherein the dialog box management information for each application or the dialog box management information for each mobile web comprises one or more information among dialog box exposure condition information for configuring exposure conditions of a dialog box, dialog box content information for configuring the content of a dialog box, and dialog box control information for controlling a dialog box on applications or mobile webs.

10. The dialog box management system according to claim 9, wherein the dialog box management information for each application or the dialog box management information for each mobile web further comprises content management information for controlling content exposure.

11. The dialog box management system according to claim 10, wherein the content management information responds to the dialog box content information.

12. The dialog box management system according to claim 8, wherein the usage information collection module collects one or more information among user terminal usage information for each user terminal, content usage information for each application, and content usage information for each mobile web.

13. The dialog box management system according to claim 8, wherein the transmitting and receiving module transmits one or more information among the user terminal usage information for each user terminal, the content usage information for each application, and the content usage information for each mobile web to the dialog box management system.

14. A dialog box exposure method of a user terminal, comprising:
executing applications or mobile webs to which a dialog box control program distributed from a dialog box management system is applied;
receiving dialog box management information for each application or dialog box management information for each mobile web from the dialog box management system; and
controlling exposure of a dialog box, based on the dialog box management information for each application or the dialog box management information for each mobile web.

15. A method for configuring dialog box exposure of a registrant terminal registering applications or mobile webs, the method comprising:
registering application information or mobile web information in a dialog box management system;
registering dialog box management information for each application or dialog box management information for each mobile web in the dialog box management system;
receiving a dialog box control program required to expose a dialog box of applications or mobile webs from the dialog box management system according to the dialog box management information for each application or the dialog box management information for each mobile web; and
applying the dialog box control program to the applications or the mobile webs.

16. The method for configuring dialog box exposure according to claim 15, wherein the method further comprises:
registering the application information or mobile web information in one or more advertising systems providing mobile advertisements,
receiving a program for advertisement exposure which is required to expose the mobile advertisements from the one or more advertising systems, and
applying the program for advertisement exposure to the applications or the mobile webs.

17. The method for configuring dialog box exposure according to claim 15, wherein the dialog box management information for each application or the dialog box management information for each mobile web comprises one or more information among dialog box exposure condition information for configuring exposure conditions of a dialog box, dialog box content information for configuring the content of a dialog box, and dialog box control information for controlling a dialog box on applications or mobile webs.

18. The method for configuring dialog box exposure according to claim 17, wherein the dialog box management information for each application or the dialog box management information for each mobile web further comprises advertisement management information for controlling advertisement exposure.

19. The method for configuring dialog box exposure according to claim 18, wherein the advertisement management information responds to the dialog box content information.

20. The method for configuring dialog box exposure according to claim 15, wherein the registering the dialog box management information comprises:
configuring the dialog box management information,
simulating exposure of a dialog box according to the configured dialog box management information, and
modifying the dialog box management information according to the simulation result.

21. The method for configuring dialog box exposure according to claim 15, wherein the registering the dialog box management information comprises:
configuring the dialog box management information,
receiving statistical data according to user terminal usage information or advertisement usage information, and
modifying the dialog box management information according to the statistical data.
